(19) United States
(12) Patent Application Publication
(10) Pub. No.: US 2008/0193909 A1
(43) Pub. Date: Aug. 14, 2008

(54) Magnetic drawing apparatus

(75) Inventors: Scott Marshall, New York, NY (US); Philip DiResta, Brooklyn, NY (US)

Correspondence Address: SPERRY ZODA AND KANE;SUITE D, ONE HIGHGATE DRIVE, TRENTON, NJ, 08618, US

(73) Assignee: FAB/Starpoint

(21) Appl. No.: 11/900,710

(22) Filed: Sep. 13, 2007

Related U.S. Application Data
(60) Provisional application No. 60/900,771, filed on Feb. 12, 2007.

(51) Int. Cl. B43L 1/00

(52) U.S. Cl. 434/409

(57) ABSTRACT

A magnetic drawing tablet apparatus comprising a stationary base housing and a screen housing movable with respect thereto. The screen housing will contain a magnetic drawing screen which is sealed and includes writing medium suspended therein which can create an image on the screen responsive to contacting thereof with a magnetic stylus. An magnetic erasing member is secured with respect to the base and extends into the screen housing to a position adjacent the magnetic screen. When the screen housing is moved between a docked position engaging the base and an extended position away from the base, erasing of images on the magnetic screen is achieved by passing the magnetic screen adjacently over the magnetic eraser. Sliding the screen housing relative to the base will preferably expose a decorative panel therebeneath. A receptacle in the base may be provided for storage of drawings templates and a magnetic style for writing may be mounted in a hole defined in the base.

This patent application claims filing date priority of U.S. Provisional Patent Application No. 60/900,771 filed Feb. 12, 2007 on a “Magnetic Drawing Tablet” filed by the identical inventors, namely, Scott Marshall and Philip DiResta and assigned to the same entity, namely, FAB/Starpoint. The entire content of Provisional Patent Application No. 60/900,771 filed Feb. 12, 2007 is hereby incorporated into the present patent application by reference.

### BACKGROUND OF THE INVENTION

1. Field of the Invention

The present invention pertains to the field of drawing tablet and, more particularly, magnetic drawing tablets which are preferably constructed with a housing which contains a magnetic drawing screen having a ferrous liquid suspended therewithin inside of a honeycomb or other similar modular lattice containment means. With this magnetic screen configuration a magnetic stylus can be placed in contact with the screen surface to allow the user to create an image in the magnetic drawings medium contained within the magnetic screen. Such images are formed by attracting the ferrous liquid and white marking material to the upper internal surface of the screen within each modular segment or honeycomb area.

It is preferable that an erasing means be included for causing the formed image to selectively be erased. Many prior art devices disclose various different types of eraser systems. Some of these systems include a strip magnet positionable near the screen for refreshing of the magnetic drawing medium within the chambers of the magnetic drawing screen to effectively “erase” any images formed by arrangement of the magnetic drawing medium. Such erasing means can include a magnet movable along the screen in contact or immediately adjacent to the lower surface of thereof for facilitating this erasing step. This erasing action is achieved by attracting of the ferrous liquid in the screen downwardly which leaves the viewable upwardly facing screen surface blank and ready to receive another image formed thereon as desired. These movable erasers can include various configurations of magnets mounting in such a manner that they normally require precisely aligned internal guides to prevent jamming or binding. This construction tends to have serious maintenance requirement when one considers that this device is an educational or amusement sketching device most commonly used by a young person. For such persons the manual manipulation of such delicate controls is somewhat difficult or could easily be damaged by rough usage. These eraser magnets are normally provided with an external finger grasping mechanism which needs to be grasped and moved in order to fully erase. Such manual operation is somewhat difficult in view of the required cantilever operation usually required in order to achieve full erasing across the entire surface of the magnetic drawing board.

2. Description of the Prior Art

A number of patents have been granted on various types of writing boards some of which include magnetic display features and some of which include erasing capabilities such as shown in U.S. Pat. No. 3,103,751 patented to W. J. McDonald on Sep. 17, 1963 on a “Chalkless Writing Board”; and U.S. Pat. No. 3,460,276 patented Aug. 12, 1969 to e. G. Payne on a “Bistable Visual Display Device”; and U.S. Pat. No. 3,509,644 patented May 5, 1970 to M. P. Santell et al on a “Self-Cleaning Blackboard”; and U.S. Pat. No. 4,143,472 patented Mar. 13, 1979 to Y. Murata et al and assigned to Pilot Man-Nen Hitsu Kabushiki Kaisha on a “Displaying Magnetic Panel And its Display Device”; and U.S. Pat. No. 4,288,936 patented Sep. 15, 1981 to H. Okutsu and assigned to Pilot Man-Nen-Hitsu Kabushiki on a “Wall-Hanging Type Magnetic Displaying Device”; and U.S. Pat. No. 4,368,952 patented Jan. 18, 1983 to Y. Murata et al and assigned to Pilot Man-Nen-Hitsu Kabushiki Kaisha on a “Magnetic Display Panel Using Reversal Magnetism”; and U.S. Pat. No. 4,451,985 patented Jun. 5, 1984 to B. C. Pullman on a “Drawing Apparatus”; and U.S. Pat. No. 4,536,428 patented Aug. 20, 1985 to Y. Murata and assigned to Pilot Man-Nen-Hitsu Kabushiki Kaisha on a “Magnetic Display Panel”; and U.S. Pat. No. 4,643,684 patented Feb. 17, 1987 to Y. Murata et al and assigned to Pilot Man-Nen-Hitsu Kabushiki Kaisha on a “Magnetic Display Panel”; and U.S. Pat. No. 4,675,476 patented Jun. 23, 1987 to T. Kobayashi and assigned to NEC Corporation on a “Magnetophoresis Type Display And Graphic Input/Output Device Using The Same”; and U.S. Pat. No. 4,804,327 patented Feb. 14, 1989 to S. H. Miller on a “Magnetic Tracing Apparatus”; and U.S. Pat. No. 4,931,019 patented Jun. 5, 1990 to K. T. Park and assigned to Pennwalt Corporation on an “Electrostatic Image Display Apparatus”; and U.S. Reissue Pat. No. Re. 33,363 patented Oct. 2, 1990 to S. H. Miller on a “Magnetic Tracing Apparatus”; and U.S. Pat. No. 5,018,979 patented May 28, 1991 to M. Gilano et al and assigned to The Ohio Art Company on a “Magnetic Visual Display”; and U.S. Pat. No. 5,057,363 patented Oct. 15, 1991 to M. Nakanishi and assigned to Japan Capsular Products Inc. on a “Magnetic Display System”; and U.S. Pat. No. 5,112,229 patented May 12, 1992 to M. A. Gilano et al and assigned to The Ohio Art Company on a “Magnetic Visual Display”; and U.S. Pat. No. 5,151,032 patented Sep. 29, 1992 to T. Igawa and assigned to Kabushiki Kaisha Pilot on a “Magnetophoretic Display Panel”; and U.S. Pat. No. 5,186,631 patented Feb. 16, 1993 to H. Okutsu and assigned to Kabushiki Kaisha Pilot on a “Magnetic Display Device”; and U.S. Pat. No. 5,295,837 patented to M. Gilano et al on Mar. 22, 1994 and assigned to The Ohio Art Company on a “Magnetic Visual Display”; and U.S. Pat. No. 5,411,398 patented May 2, 1995 to M. Nakanishi et al and assigned to Japan Capsular Products, Inc. on a “Magnetic Display System”; and U.S. Pat. No. 5,429,503 patented Jul. 4, 1995 to Y. Murata et al and assigned to Kabushiki Kaisha Pilot on a “Magnetic Display Panel Including Substrates And Multicell Structure Comprising Nonorientational And Uncrystallized Polyester Resin”; and U.S. Pat. No. 5,478,084 patented Dec. 26, 1995 to Y. Itkis on a “Magnetic Bingo Board”; and U.S. Pat. No. 5,674,104 patented Oct. 7, 1997 to M. Ohashi et al and assigned to Tomy, Ltd. on a “Magnetic Pen”; and U.S. Pat. No. 5,820,385 patented Oct. 13, 1998 to M. Ohashi et al and assigned to Tomy Company, Ltd. on a “Magnetic Display Apparatus”; and U.S. Pat. No. 5,997,309 patented Dec. 7, 1999 to J. Metheny et al on an “Erasable Drawing Board”; and U.S. Pat. No. 6,092,294 patented Jul. 25, 2000 to K. S. Mak and assigned to Hop Lee Cheong Industrial Company Limited on a “Drawing Board”; and U.S. Pat. No. 6,103,347 patented Aug. 15, 2000 to T. Nojima et al and assigned to Kabushiki Kaisha Pilot on a “Magnetic Display Panel”; and U.S. Pat. No. 6,183,262 patented Feb. 6, 2001 to S. C. Tseng on a “Magnetic Drawing Board Structure”; and U.S. Pat. No. 6,196,848 patented Mar. 6, 2001 to Y. Yamazaki and assigned to Takara Co., Ltd. on an “Infant Toy For Drawing Colored Picture”; and U.S. Pat. No. 6,315,573 patented Nov. 13, 2001 to K. Hirota et al and assigned to Kyowa Electric and Chemical Co. Ltd. on an “Article Placing Table With An Erasable Writing Device”; and U.S. Pat. No. 6,416,329 patented Jul. 9, 2002 to K. Hirota et al and assigned to Kyowa Electric and Chemical Co., Ltd. on a “Writing Device For Practice In Writing Characters”; and U.S. Pat. No. 6,419,498 patented Jul. 16, 2002 to M. Ikeda et al and assigned to Kabushiki Kaisha Pilot on a “Magnetic Material-Inverting Display Panel”; and U.S. Pat. No. 6,450,401 patented Sep. 17, 2002 to K. Hirota et al and assigned to Kyowa Electric and Chemical Co., Ltd. on a “Writing Board With Electronic Calculator”; and U.S. Pat. No. 6,517,355 patented Feb. 11, 2003 to J. Long et al and assigned to Hasbro, Inc. on a “Magnetically Responsive Writing Device With Automated Output”; and U.S. Pat. No. 6,550,812 patented Apr. 22, 2003 to A. G. Castillo et al and assigned to Avery Dennison Corporation on a “Magnetic Write/Erase Binder”; and U.S. Pat. No. 6,585,523 patented Jul. 1, 2003 to M. Tokunaga et al and assigned to Kabushiki Kaisha Pilot on a “Magnetic Material-Inverting Display Panel”; and U.S. Pat. No. 6,629,847 patented Oct. 7, 2003 to H. Satoh and assigned to Takara Co., Ltd. on a “Magnetic Display Panel And Method For Producing The Same”; and U.S. Pat. No. 6,805,559 patented Oct. 19, 2004 to K. S. Mak and assigned to Hop Lee Cheong Industrial Company Limited on an “Erasable Graphic Panel”; and U.S. Pat. No. 6,878,306 patented Apr. 12, 2005 to T. S. Gao and assigned to Tsuen Lee Metals & Plastic Toys Co., Ltd. on a “Magnetic Writing Screen Dispersion Media”; and U.S. Pat. No. 6,932,613 patented to J. Z. Olsen et al on Aug. 23, 2005 and assigned to Handwriting Without Tears, Inc. on a “Pre-Writing Teaching Aid And Method To Assist Beginning Writers In Creative Letters”; and U.S. Pat. No. 6,943,772 patented Sep. 13, 2005 to M. Yasuda and assigned to The Pilot Ink Co., Ltd. on a “Magnetic Display Device”; and U.S. Pat. No. 7,015,892 patented Mar. 21, 2006 to Y. Nihira et al and assigned to Takara Co., Ltd. on a “Magnetophoretic Display Panel”; and U.S. Pat. No. 7,070,856 patented Jul. 4, 2006 to T. Iwasaki et al and assigned to A-Son Enterprise, Inc. and Tocom Corporation on a “Front Face Erasable Microcapsule Magnetophoretic Display Sheet, Erasing Magnet And Writing Magnet”; and United States Publication No. US 2005/0239038 A1 published to J. Z. Olsen et al on Oct. 27, 2005 on a “Pre-Writing Teaching Aid And Method To Assist Beginning Writers In Creating Letters”; and U.S. Design Pat. No. Des. 279,489 patented Jul. 2, 1985 to K. S. Mak and assigned to Hop Lee Cheong Industrial Co. Ltd on a “Drawing Toy”; and U.S. Design Pat. No. Des. 279,490 patented Jul. 2, 1985 to K. S. Mak and assigned to Hop Lee Cheong Industrial Co. Ltd. on a “Drawing Toy”; and U.S. Design Pat. No. Des. 327,498 patented Jun. 30, 1992 to J. E. Watson et al and assigned to The Ohio Art Company on a “Drawing Screen”; and U.S. Design Pat. No. Des. 336,751 patented Jun. 22, 1993 to K. S. Mak and assigned to Hop Lee Cheong Industrial Co. on a “Drawing Board”; and U.S. Design Pat. No. Des. 356,335 patented Mar. 14, 1995 to K. S. Mak and assigned to Hop Lee Cheong Industrial Company Ltd. on a “Drawing Board”; and U.S. Design Pat. No. Des. 356,336 patented Mar. 14, 1995 to K. S. Mak and assigned to Hop Lee Cheong Industrial Company Ltd. on a “Drawing Board”; and U.S. Design Pat. No. Des. 356,824 patented Mar. 28, 1995 to K. S. Mak and assigned to Hop Lee Cheong Industrial Co., Ltd. on a “Drawing Board”; and U.S. Design Pat. No. Des. 358,608 patented May 23, 1995 to K. S. Mak and assigned to Hop Lee Cheong Industrial Co. Ltd. on a “Drawing Board”; and U.S. Design Pat. No. Des. 359,984 patented Jul. 4, 1995 to K. S. Mak on a “Drawing Board”; and U.S. Design Pat. No. Des. 363,511 patented Oct. 24, 1995 to T. W. Hui and assigned to Vtech Industries, Inc. on a “Housing For Electronic Drawing Toy”; and U.S. Design Pat. No. Des. 415,121 patented Oct. 12, 1999 to M. Uematsu et al and assigned to FANUC Limited on a “Teaching Pendant for An Industrial Robot”; and U.S. Design Pat. No. Des. 419,599 patented to K. S. Mak on Jan. 25, 2000 and assigned to Hop Lee Cheong Industrial Company Ltd. on a “Toy Drawing Board”; and U.S. Design Pat. No. Des. 443,304 patented Jun. 5, 2001 to K. S. Mak and assigned to Hop Lee Cheong Industrial Company Limited on a “Toy Drawing Board”; and U.S. Design Pat. No. D 460,113 patented Jul. 9, 2002 to R. O. Hainey, II et al and assigned to Toynetix Company Ltd. on an “Electronic Drawing Apparatus”; and U.S. Design Pat. No. D 461,845 patented Aug. 20, 2002 to N. Ishida et al and assigned to Sega Toys, Ltd. on an “Educational Illustration Machine”; and U.S. Design Pat. No. D 467,971 patented Dec. 31, 2002 to K. S. Mak and assigned to Hop Lee Cheong Industrial Company Limited on a “Toy Drawing Board”; and U.S. Design Pat. No. D 479,716 patented Sep. 16, 2003 to J. J. Miller and assigned to Mattel, Inc. on a “Hand-Held Electronic Drawing Device”; and U.S. Design Pat. No. D 498,269 patented Nov. 9, 2004 to T. Shirai and assigned to Tony Company, Ltd. on a “Drawing Toy”.

### SUMMARY OF THE INVENTION

The present invention provides a magnetic drawing apparatus having a base housing which preferably defines a template retaining chamber for holding chambers therein and also defines a stylus retaining chamber for holding a stylus selectively therein. The base housing also preferably defines a screen guide recess for facilitating sliding movement between the screen housing and the base housing.

A screen housing is also provided movably secured with respect to the base housing such as to define a screen viewing area preferably therewithin.

A screen housing is movable between a docked position adjacent the base housing and an extended position extending outwardly away therefrom. This screen housing is movable preferably in a slidable manner with respect to the base housing between the docked and extended positions.

The screen housing preferably may also include a docking detent adapted to exert a flexibly resilient bias against the base housing responsive to positioning of the screen housing in the docked position to facilitate retaining it in the docked position. The screen housing also preferably defines an access opening therein which provides the screen viewing area with the magnetic drawing screen mounted extending thereover such that it can be viewed externally to facilitate defining of images thereon magnetically.

A decorative theme panel may also be defined on the base housing at a position beneath the screen housing whenever the screen housing is in the docked position. The decorative theme panel is designed to be exposed for viewing thereof responsive to movement of the screen housing to the extended position. The screen housing is also preferably slidably movable along the screen guide recess to facilitate movement between the extended and docked positions. It should be appreciated that the screen guide recess facilitates the guiding of the slidable movement of the screen housing as it moves between the docked position at the base housing and the extended position wherein it extends outwardly therefrom.

Preferably the present invention will include a magnetic drawing screen attached to the screen housing adjacent the screen viewing area thereof for selectively facilitating the forming of images. The screen viewing area of the screen housing is externally accessible for forming images magnetically therein and it is movable along with the screen housing between the docked position and the extended position. Furthermore the magnetic drawing screen will preferably define an obverse surface facing outwardly from the screen housing upon which magnetic images can be formed by contacting thereof with magnetic implements. The magnetic drawing screen also includes a reverse surface facing inwardly therefrom oppositely from the obverse surface against which an eraser means can be positioned to facilitate erasing thereof.

The present invention further includes a magnetic eraser mechanism secured to the base housing and extending outwardly therefrom into the screen housing to a position immediately adjacent the magnetic drawing screen. This magnetic drawing screen is adapted to move immediately adjacently over the magnetic eraser responsive to movement of the screen housing between the docked position and the extended position for refreshing of the magnetic drawing screen by erasing of any images displayed on it. The magnetic eraser is preferably positioned within the screen housing at a position immediately adjacent the reverse surface of the magnetic drawing screen to facilitate erasing thereof responsive to movement of the screen housing between the docked position and the extended position as the reverse surface of the magnetic drawing screen passes adjacently over the magnetic eraser. Preferably the magnetic eraser is positioned in abutment with respect to the reverse surface of the magnetic drawing screen to facilitate full and complete erasing thereof responsive to movement of the screen housing between the docked position and the extended position.

A magnetic stylus can be included with the apparatus of the present invention for facilitating the forming of images on the magnetic drawing screen. This magnetic stylus is preferably selectively positionable within the stylus retaining chamber defined in the base housing to facilitate storage thereof. Also at least one drawing template will preferably be included which defines depressions therein for facilitating guiding of the magnetic stylus or other magnetic drawing implement when in abutment with respect to the magnetic drawing screen for forming decorative images thereon. The template retaining chamber defined in the base is adapted to receive the one or more drawing templates therein for storage as desired.

The present invention may also include an eraser retaining bracket designed to hold the magnetic eraser therewithin. This eraser retaining bracket is preferably positioned within the screen housing such as to extend outwardly therefrom into engagement with respect to the base housing to facilitate maintaining of the magnetic eraser stationary with respect to the base housing responsive to movement of the screen housing between the docked position and the extended position thereof for facilitating erasing of the magnetic drawing screen while passing adjacently over the magnetic eraser.

Also a plurality of threaded fasteners may be included extending through the base into engagement with respect to the eraser retaining bracket defined above to facilitate maintaining of the magnetic eraser stationary with respect to the base housing responsive to movement of the screen housing between the docked position and the extended position. In the preferred embodiment of the present invention the magnetic eraser is adhesively secured to the eraser retaining bracket for maintaining securement therebetween. With this construction the eraser retaining bracket can include at least two mating pin members extending outwardly from the screen housing into securement with respect to the base housing. In this manner the screen housing will define at least two main pin slots extending longitudinally therealong with one of the mating pin members extending through each one of the mating pin slots to facilitate freedom of movement of the screen housing and the magnetic drawing screen with respect to the base housing and the magnetic eraser responsive to movement of the screen housing between the docked position and the extended position selectively.

The present invention may further include a movement guide means which facilitates the control of movement of the screen housing relative to the base housing between the docked position and the extended position. This movement guide means may include one or more screen guide pins positioned on the screen housing and base guide channels defined in the base housing. The base guide channels are adapted to receive the screen guide pins extending therewithin to be movable therealong to facilitate control of movement of the screen housing between the docked position and the extended position thereof.

Alternatively or additionally the movement guide means of the present invention can include base guide pins positioned on the base housing as well as screen guide channels defined in the screen housing. The screen guide channels are adapted to receive the base guide pins extending therewithin and movable therealong to facilitate control of movement of the screen housing between the docked position and the extended position thereof respectively.

In those configurations of the present invention including the stylus and the stylus retaining chamber a stylus retaining detent can be included positioned adjacent the stylus retaining chamber. The detent is adapted to exert flexibly resilient bias laterally against the magnetic stylus when positioned within the stylus retaining chamber for facilitating retaining thereof therewithin selectively.

It is an object of the novel magnetic drawing apparatus of the present invention to be usable conveniently by young persons and children.

It is an object of the novel magnetic drawing apparatus of the present invention to facilitate erasing of a magnetically drawn image from a magnet drawing screen.

It is an object of the novel magnetic drawing apparatus of the present invention to facilitate storage of drawing implements such as templates within a receptacle defined within a base.

It is an object of the novel magnetic drawing apparatus of the present invention to provide a screen housing which is slidably movable relative to a base member to facilitate erasing of magnetic images from the screen.

It is an object of the novel magnetic drawing apparatus of the present invention to provide a mechanism for erasing that is simple and easy to maintain because it need minimal maintenance.

It is an object of the novel magnetic drawing apparatus of the present invention to be of minimal capital cost.

It is an object of the novel magnetic drawing apparatus of the present invention while uses a mechanical erasing mechanism that includes a fixed magnetic strip and a screen housing that is moveable to cause the magnetic drawing screen to move adjacently over said strip to facilitate erasing thereof selectively.

It is an object of the novel magnetic drawing apparatus of the present invention to provide an erasing system for a magnetic drawing board that does not require manipulation of any dials or levels or handles in order to achieve full refreshing of the magnetic drawing surface.

### BRIEF DESCRIPTION OF THE DRAWINGS

While the invention is particularly pointed out and distinctly described in the concluding portions herein, a preferred embodiment is set forth in the following detailed description which may be best understood when read in connection with the accompanying drawings, in which:

FIG. 1 is a three-quarter perspective view of the front of an embodiment of the magnetic drawing apparatus of the present invention with the screen housing shown in the docked position;

FIG. 2 is a cross-section of the embodiment shown in FIG. 1 along lines 2-2;

FIG. 3 is a cross-section of the embodiment shown in FIG. 1 along lines 3-3;

FIG. 4 is a side plan view of the embodiment shown in FIG. 1 as viewed from the left;

FIG. 5 is a three-quarter perspective view of the embodiment shown in FIG. 1 with the screen housing shown in the extended position;

FIG. 6 is a rear plan view of the back of an embodiment of the base housing showing the eraser bar movably mounted therein slidable along the mating pin slots;

FIG. 7 is a side plan view of an embodiment of a magnetic stylus;

FIG. 8 is an end plan view of an embodiment of the magnetic eraser of the present invention shown mounted within an eraser retaining bracket with mating pin members extending downwardly therefrom;

FIG. 9 is a front plan view of the embodiment of the erasing mechanism shown in FIG. 8;

FIG. 10 is a front plan view of an embodiment of a template of the present invention;

FIG. 11 is a rear plan view of an embodiment of a base housing of the present invention showing the template retaining chamber defined therein;

FIG. 12 is a front plan view of an embodiment of the base housing of the present invention clearly illustrating the decorative theme panel and base guide channels as well as the base guide pins; and

FIG. 13 is a rear plan view of the front half of an embodiment of the base housing of the present invention showing the ridges defining the stylus retaining chamber and also showing the stylus retaining detent.

### DETAILED DESCRIPTION OF THE PREFERRED EMBODIMENT

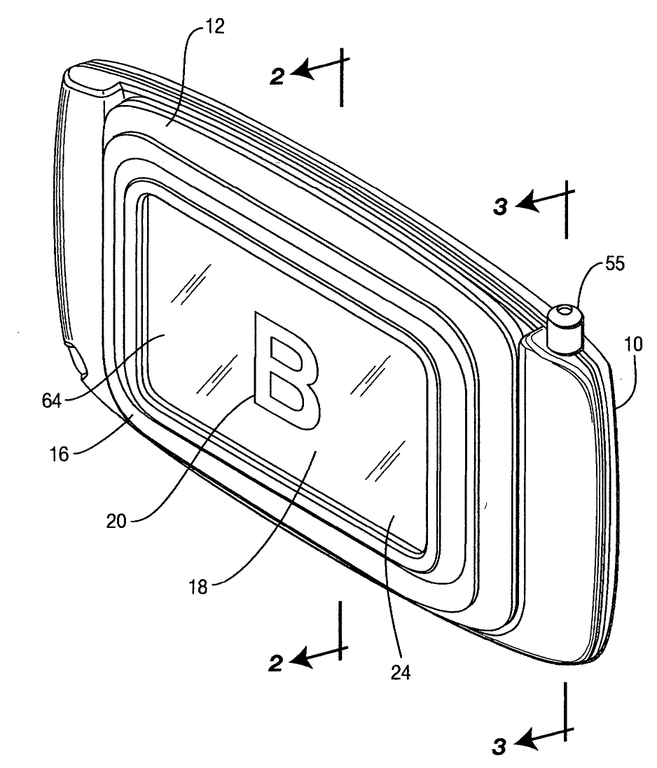

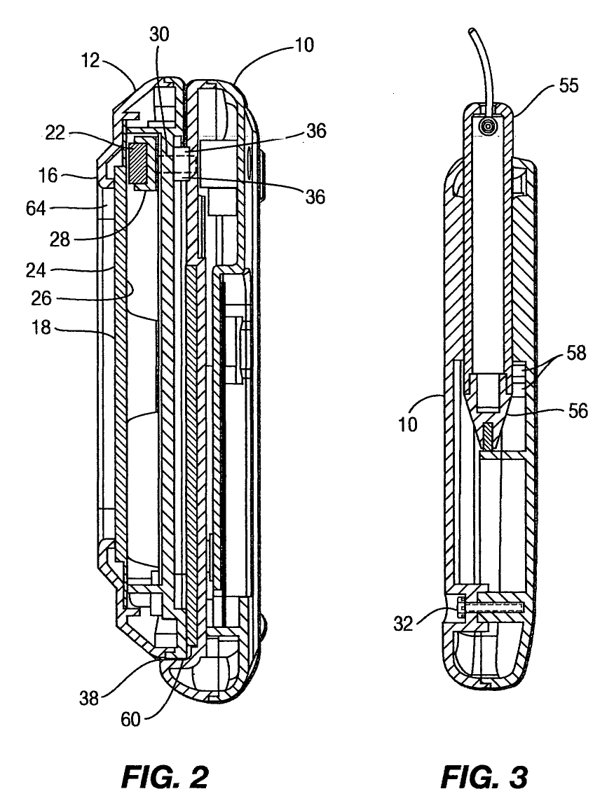

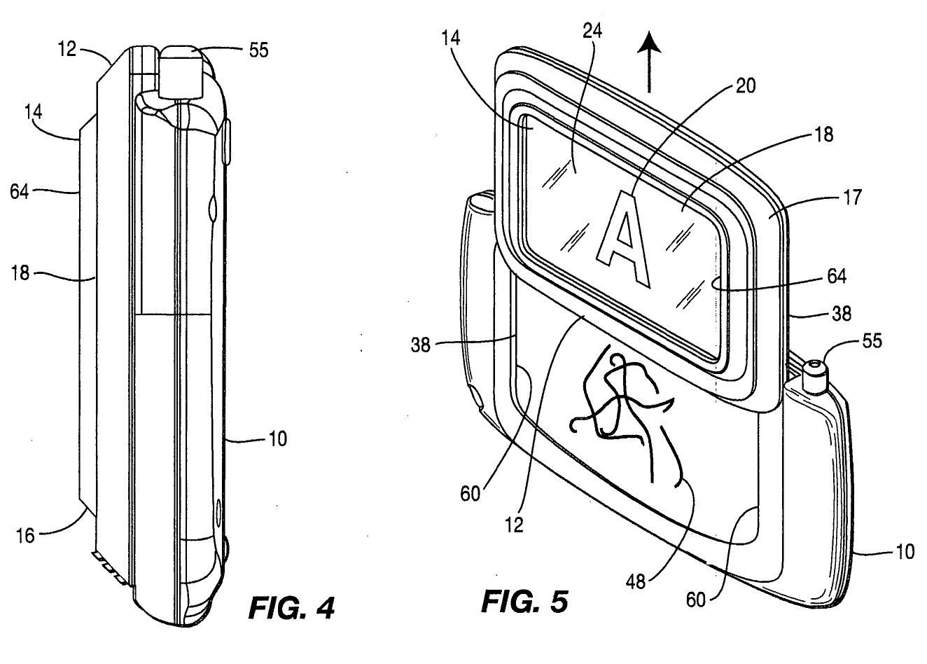

The present invention provides a base housing 10 with a screen housing 12 movably attached hereto. Screen housing 12 is movable relative to the base housing 10 between a docked position 16 and an extended position 17. These two positions are generally best shown in FIG. 1 which shows the docked position and FIG. 5 which shows the extended position.

The screen housing 12 retains a magnetic drawing means such as a magnetic drawing screen 18 mounted therein and viewable through a screen viewing area 14. The magnetic drawing screen 18 is adapted to be contacted by any type of an apparatus which will draw an image on the screen. Normally the magnetic means for drawing such an image on the magnetic drawing screen 18 will be a magnetic stylus 55. When the stylus 55 is brought into abutment with the screen 18 magnet images 20 are formed thereon. These devices are normally utilized by youngsters such as children, both boys and girls, for forming fanciful images thereon.

Once the drawing is completed it is then necessary to erase the image formed on the magnetic drawing screen 18. It is in the process of an apparatus for erasing of this image that the present invention is particularly novel. In particular, a magnetic eraser 22 is mounted within an eraser retaining bracket 28 such as by adhesive or other similar securement means. The eraser retaining bracket 28 is normally a longitudinally extending member as shown best in FIG. 9 and retains the magnetic strip or erasing means 22 defined therein as shown best in FIGS. 8 and 9.

In the preferred configuration of the present invention the eraser retaining bracket 28 will be fixedly secured with respect to the base housing 10. This securement and mounting is provided by mating pin members 30 which form an integral part of or are separately attached with respect to the eraser retaining bracket 28 and extend outwardly therefrom. These mating pin members 30 will preferably be secured by threaded fasteners 32 with respect to the base housing 10. The magnetic eraser 22 and the eraser retaining bracket 28 will both be contained preferably within the screen housing 12. Thus, as the screen housing 12 is moved between the docked position 16 and the extended position 17, the magnetic eraser 22 and the eraser retaining bracket 28 will remain stationary relative to the moving screen housing 12. In the preferred configuration of the present invention the magnetic eraser 22 will be positioned immediately adjacent to the reverse surface 26 of the magnetic drawing screen 18. Thus, as the screen housing 12 is moved between the docked position 16 and the extended position 17, the magnetic eraser 22 will be brought into close proximity to all portions of the reverse surface 26 of the magnetic drawing screen 18 to thereby achieve full erasing or refreshing thereof.

The screen housing 12 will define longitudinally extending mating pin slots 36 therewithin with one of the mating pin members 30 extending through each one of the longitudinally extending mating pin slots 36. In this manner the movement of the screen housing 12 relative to the base housing 10 between the extended position 17 and the docked position 16 will not be inhibited because of the positioning of the stationary erasing means, in particular the magnetic eraser 22 and the eraser retaining bracket 28, within the screen housing 12 as it moves. Since the base housing remains stationary and since the magnetic erasing means is stationary with respect to the base housing whenever the screen housing 12 is movable relative to the base housing between the extended and docked positions, it will be possible to achieve full erasing of all areas of the magnetic drawing screen 18 because these mating pin slots 36 will allow the screen 12 to move in the completely opposite positions between the extended and docked positions relative to the stationary base housing 10.

The obverse surface 24 of the magnetic drawing screen 18 is the surface upon which the images are formed by the use of the magnetic stylus 55. It is important that the movement of the screen housing 12 relative to the base housing 10 be properly guided and this guiding is provided by the inclusion of movement guide 38. The movement guides 38 can include two basic means preferably. The first means would include screen guide pins 40 defined in the screen housing 12 which are extendable and guided by base guide channels 42 defined in the base housing 10. Alternatively the movement guides 38 can comprise base guide pins 44 included in the construction of the base housing 10 which are adapted to extend in and be guided by screen guide channels 46 defined in the screen housing 12.

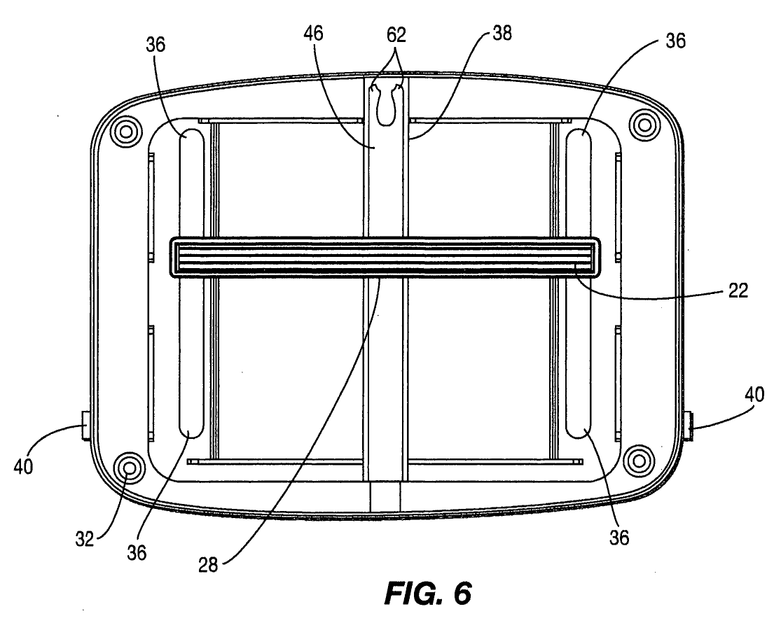

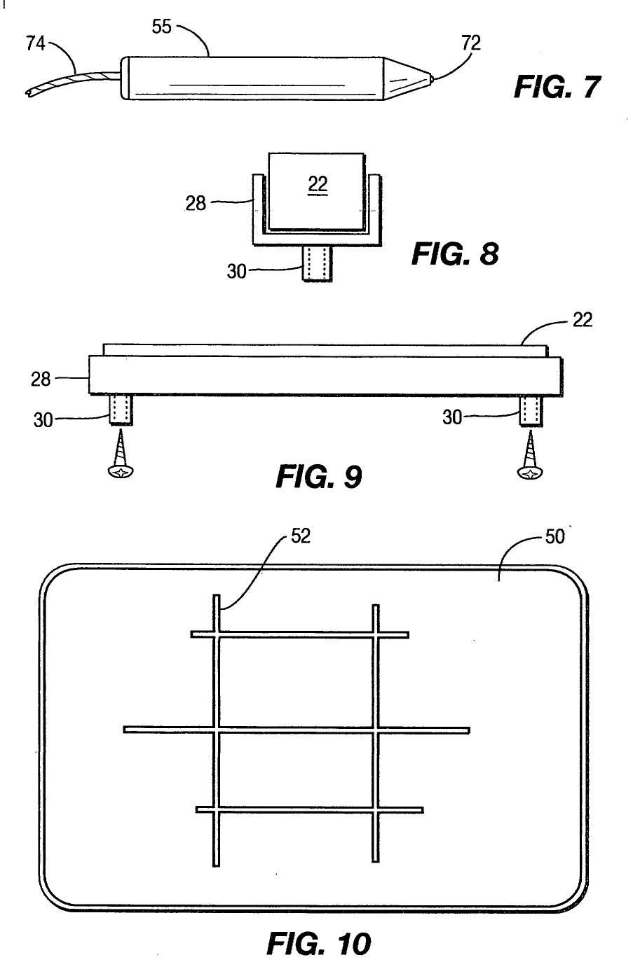

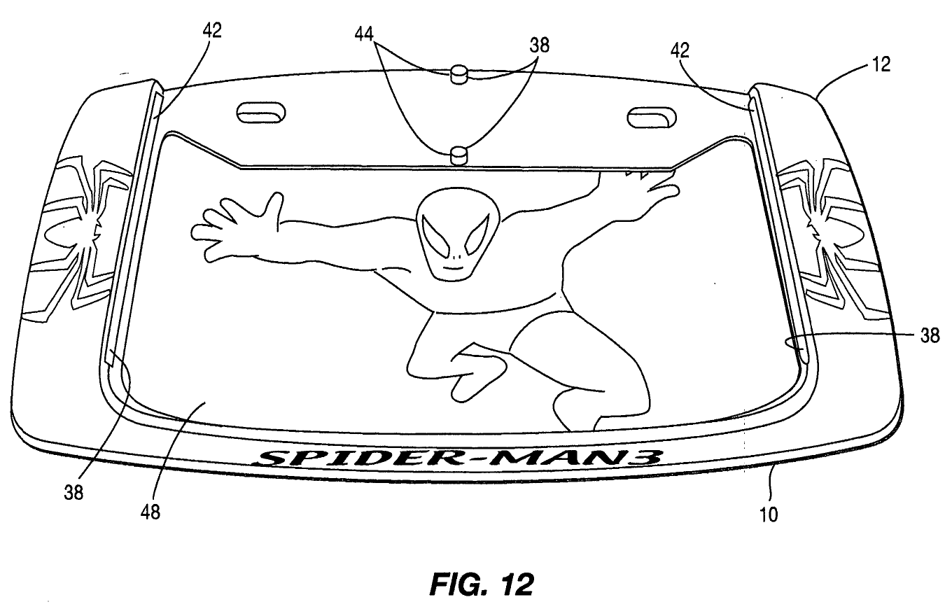

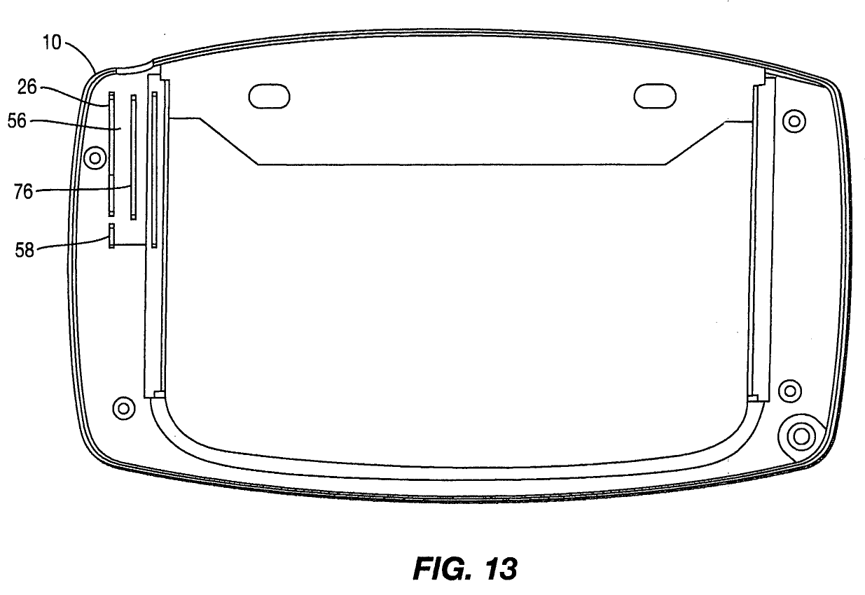

This construction is best shown in FIG. 12 wherein the base guide channels 42 are shown on the opposite lateral sides of the screen guide recess 60. The screen guide recess 60 is a generally flat slot extending across the upper surface of the base housing 10 with the base guide channels 42 defined as slots in the opposite outer edges thereof. These base guide channels 42 are adapted to receive the screen guide pins 40 extending thereinto to facilitate guiding of movement of the screen housing 12. The screen guide pins 40 are shown best in FIG. 6 on the opposite lower lateral edges of the screen housing 12. Thus, as the screen housing 12 is moved between the docked position 16 and the extended position 17, the screen guide pins 40 will extend into and be guided by the associated base guide channels 42.

Furthermore, guiding of the sliding movement of the screen housing 12 within the base housing 10 is achieved by the combination of the base guide pins 44 shown in FIG. 12 and the screen guide channel means 46 shown in FIG. 6. The movement guides 38 in FIG. 12 comprise two vertically extending pins each of which is adapted to be positioned within the screen guide channel 46 shown in FIG. 6. The combination of these base guide pins 44 and the screen guide channels 46 will facilitate the alignment of the screen housing 12 relative to the base housing 10 as it moves between the docked position 16 and the extended position 17.

It is also preferable that once the screen housing 12 is fully positioned in the docked position 16 that it be retained therein selectively until the user purposefully decides to initiate erasing thereof by movement of the screen housing 12 toward the extended position 17. Therefore, a docking detent 62 is shown in FIG. 6 which is adapted to grasp the uppermost of the base guide pins 44 as shown in FIG. 12 by exerting laterally directed bias thereon for facilitating retaining of the screen housing 12 in the fully docked position 16. The user will need to exert a small amount of force to overcome the lateral pressure exerted by the docking detent 62 in order to disengage the docking detent 62 from the uppermost base guide pin 44 in order to initiate movement toward the extended position 17. Without the exertion of this additional force the screen housing 12 will be retained at the fully docked position 16 by the docking detent 62.

In the preferred configuration of the present invention the screen housing 12 will preferably define an access opening 64 therewithin which will provide direct access for the user to the obverse surface 24 of the magnetic drawing screen 18 for forming images thereon such as by direct abutment of the magnetic stylus 55 thereon while extending through the access opening means 64.

It is preferable that the present invention also include a decorative theme panel 48 defined on the exterior surface of the base housing 10 at a position below the normal location of the screen housing 12 when it is in the docked position 16. In this manner movement of the screen housing 12 from the docked position 16 toward the extended position 17 will expose the decorative theme panel 48 on the base housing 12 for viewing by the user. This decorative theme panel 48 can include depictions of any theme commonly found to be enjoyable by young persons. Movement of the screen housing 12 when returning from the extended position 17 to the docked position 16 will again obstruct the view of the decorative theme panel 48 whenever the screen housing 12 is in the fully docked position 16.

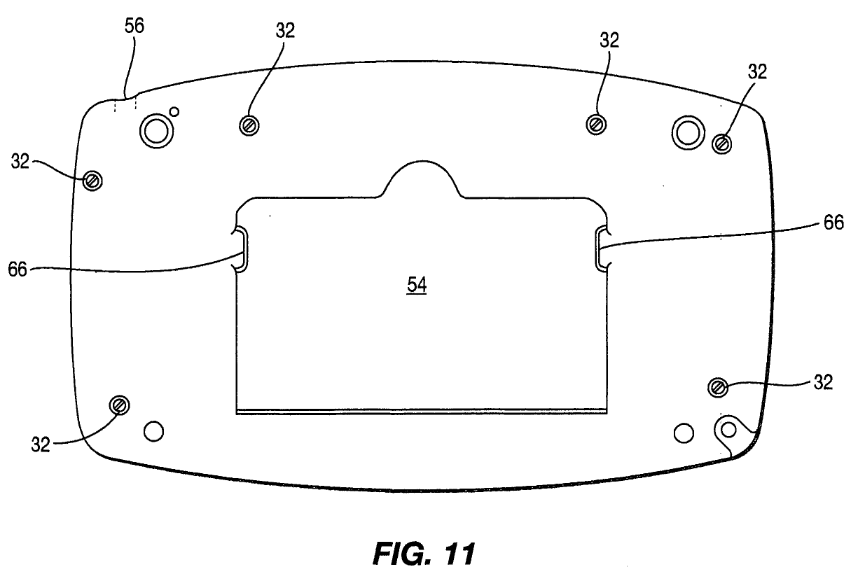

The base housing 10 of the present invention preferably defines a template retaining chamber 54 most preferably defined in the lower surface of the base housing 10 opposite from the point of movable securement of the screen housing 12 with respect thereto. This template retaining chamber 54 is preferably defined to receive one or more of a plurality of drawing templates 50 therein such that the templates are readily accessible to facilitate use in forming magnetic images 20 on the magnetic drawing screen 18 while allowing storage thereof easily within the template retaining chamber 54. Storage of drawing templates 50 within the template retaining chamber 54 is made more secure by the inclusion of template retaining tabs 66 located peripherally around the template retaining chamber 50 by the surrounding portion of the base housing 10. Preferably the drawing templates 50 retained within the template retaining chamber 54 will define a plurality of depressions 52 thereon which facilitates the guiding of movement of the magnetic stylus 55 of the present invention relative to the magnetic drawing screen 18 for forming the defined images of the template depressions 52 thereon. Removal of the drawing templates 50 from the template retaining chamber 54 is enhanced by the inclusion of a finger access recess 68 as shown best in FIG. 11. This finger access 68 will allow the user to place a finger or fingernail beneath the drawing template 50 when it is positioned within the chamber 54.

The inclusion of the magnetic stylus 55 of the present invention is an important consideration because this is the primary means for forming images upon the magnetic drawing screen 18 of the present invention. The construction of each magnetic stylus will include a stylus body 70 to facilitate grasping thereof and a stylus magnetic tip 72 for forming of images on the screen 18 by the magnetic field emanating therefrom. The base housing 10 will preferably define a stylus retaining chamber 56 therein adapted to receive the magnetic stylus 55 positioned therein for retaining therein selectively. The stylus retaining chamber 56 will preferably be defined by a plurality of internal ridge members 76 extending vertically and defining a generally round opening in which the stylus can be positioned. A stylus retaining detent 58 is included defined in the base positioned adjacent to the stylus retaining chamber 54. This stylus retaining detent 58 is adapted to exert a flexibly resilient bias against the magnetic stylus 55 when positioned within the stylus retaining chamber 54 in order to facilitate selectively retaining thereof in position within the chamber. A lanyard 74 can be secured to the base and to the stylus to prevent the stylus from being displaced or otherwise lost.

The overall construction of the apparatus of the present invention is particularly novel in the inclusion of a means for erasing of the magnetic surface which does not use any external knobs, levers or control members but is merely initiated by the sliding movement of the screen relative to the base. This construction is not shown or suggested in any of the prior art and is one of the most important novel aspects of the present invention.

While particular embodiments of this invention have been shown in the drawings and described above, it will be apparent that many changes may be made in the form, arrangement and positioning of the various elements of the combination. In consideration thereof, it should be understood that preferred embodiments of this invention disclosed herein are intended to be illustrative only and not intended to limit the scope of the invention.

We claim:

1. A magnetic drawing apparatus comprising:
A. a base housing;
B. a screen housing movably secured with respect to said base housing and defining a screen viewing area, said screen housing being movable between a docked position adjacent said base housing and an extended position extending outwardly away therefrom;
C. a magnetic drawing screen means attached to said screen housing adjacent said screen viewing area thereof for selectively facilitating the forming of images thereupon, said screen viewing area of said screen housing being externally accessible for forming images magnetically thereupon and being movable along with said screen housing between the docked position and the extended position; and
D. a magnetic eraser means secured to said base housing and extending outwardly therefrom into said screen housing to a position immediately adjacent said magnetic drawing screen means, said magnetic drawing screen means being adapted to move immediately adjacently over said magnetic eraser means responsive to movement of said screen housing between the docked position and the extended position for refreshing of the magnetic drawing screen means by erasing of any images displayed thereupon.

2. A magnetic drawing apparatus as defined in claim 1 wherein said screen housing is movable slideably with respect to said base housing between said docked position and said extended position.

3. A magnetic drawing apparatus as defined in claim 1 wherein said magnetic drawing screen means includes an obverse surface facing outwardly from said screen housing which is adapted to have magnetic images formed thereupon and a reverse surface facing inwardly oppositely from said obverse surface, and wherein said magnetic eraser means is positioned within said screen housing at a position immediately adjacent said reverse surface of said magnetic drawing screen means to facilitate erasing thereof responsive to movement of said screen housing between the docked position and the extended position as said reverse surface of said magnetic drawing screen means passes over said magnetic eraser means.

4. A magnetic drawing apparatus as defined in claim 3 wherein said magnetic eraser means is positioned in abutment with respect to said reverse surface of said magnetic drawing screen means to facilitate erasing thereof responsive to movement of said screen housing between said docked position and said extended position.

5. A magnetic drawing apparatus as defined in claim 1 further comprising an eraser retaining bracket with said magnetic eraser means attached thereto, said eraser retaining bracket positioned within said screen housing and extending outwardly therefrom into engagement with respect to said base housing to facilitate maintaining of said magnetic eraser means stationary with respect to said base housing responsive to movement of said screen housing between the docked position and the extended position thereof for facilitating erasing of said magnetic drawing screen means while passing adjacently over said magnetic eraser means.

6. A magnetic drawing apparatus as defined in claim 5 further comprising a plurality of threaded fasteners extending through said base housing into engagement with respect to said eraser retaining bracket to facilitate maintaining of said magnetic eraser means stationary with respect to said base housing responsive to movement of said screen housing between said docked position and said extended position.

7. A magnetic drawing apparatus as defined in claim 5 wherein said magnetic eraser means is adhesively secured to said eraser retaining bracket.

8. A magnetic drawing apparatus as defined in claim 5 wherein said eraser retaining bracket included at least two mating pin members extending outwardly from said screen housing into securement with respect to said base housing and wherein said screen housing defines at least two mating pin slot means extending longitudinally therealong with one of said mating pin members extending through each one of said mating pin slot means to facilitate freedom of movement of said screen housing and said magnetic drawing screen means with respect to said base housing and said magnetic eraser means responsive to movement of said screen housing between the docked position and the extended position.

9. A magnetic drawing apparatus as defined in claim 1 further including a movement guide means to facilitate control of movement of said screen housing with respect to said base housing between said docked position and said extended position, said movement guide means including:
A. screen guide pin means positioned on said screen housing; and
B. base guide channel means defined within said base housing, said base guide channel means adapted to receive said screen guide pin means extending therewithin to be moveable therealong to facilitate control of movement of said screen housing between said docked position and said extended position thereof.

10. A magnetic drawing apparatus as defined in claim 1 further including a movement guide means to facilitate control of movement of said screen housing with respect to said base housing between said docked position and said extended position, said movement guide means including:
A. base guide pins means positioned on said base housing; and
B. screen guide channel means defined within said screen housing, said screen guide channel means adapted to receive said base guide pin means extending therewithin and moveable therealong to facilitate control of movement of said screen housing between said docked position and said extended position thereof.

11. A magnetic drawing apparatus as defined in claim 1 further comprising a decorative theme panel defined on said base housing at a position thereon beneath said screen housing responsive to positioning of said screen housing in said docked position and being externally viewable responsive to movement of said screen housing to said extending position.

12. A magnetic drawing apparatus as defined in claim 1 further comprising at least one drawing template defining depressions therein for facilitating forming of images on said magnetic drawing screen means and wherein said base housing defines a template retaining chamber means therein which is adapted to receive at least one of said drawing templates therewithin for storage thereof.

13. A magnetic drawing apparatus as defined in claim 1 further comprising a magnetic stylus means for facilitating the forming of images on said magnetic drawings screen means.

14. A magnetic drawing apparatus as defined in claim 13 wherein said base housing defines a stylus retaining chamber means adapted to receive said magnetic stylus for retaining therewithin.

15. A magnetic drawing apparatus as defined in claim 14 wherein said base housing further includes a stylus retaining detent positioned adjacent said stylus retaining chamber means and being adapted to exert flexibly resilient bias against said magnetic stylus means when positioned within said stylus retaining chamber means for facilitating retaining thereof therewithin selectively.

16. A magnetic drawing apparatus as defined in claim 1 wherein said base housing defines a screen guide recess means therewithin with said screen housing slideably movement therealong, said screen housing being positionable within said screen guide recess means for movement thereof to the docked position and being moveable outwardly away therefrom for movement to said extended position, said screen guide recess facilitating guiding movement of said screen housing relative to said base housing during movement thereof between said docked position and said extending position.

17. A magnetic drawing apparatus as defined in claim 1 wherein said screen housing further includes a docking detent adapted to exert a flexibly resiliently bias against said base housing responsive to positioning of said screen housing in said docked position to facilitate retaining thereof in said docked position.

18. A magnetic drawing apparatus as defined in claim 1 wherein movement of said screen housing between said docked position and said extended position causes all portions of said magnetic drawing screen means to move adjacently across said magnetic eraser means to facilitate complete refreshing of said magnetic drawing screen means.

19. A magnetic drawing apparatus as defined in claim 1 wherein said screen housing defines an access opening means therein which provides said screen viewing area with said magnetic drawing screen means mounted extending thereover to be externally accessible for facilitating the formation of images thereupon.

20. A magnetic drawing apparatus comprising:
A. a base housing defining a decorative theme panel thereupon;
B. a screen housing movably secured with respect to said base housing and defining a screen viewing area, said screen housing being movable between a docked position adjacent said base housing and an extended position extending outwardly away therefrom; said screen housing being movable slideably with respect to said base housing between said docked position and said extended position, said screen housing further including a docking detent adapted to exert a flexibly resiliently bias against said base housing responsive to positioning of said screen housing in said docked position to facilitate retaining thereof in said docked position, said screen housing defining an access opening means therein which provides said screen viewing area with said magnetic drawing screen means mounted extending thereover to be externally accessible for facilitating the formation of images thereupon;
C. a magnetic drawing screen means attached to said screen housing adjacent said screen viewing area thereof for selectively facilitating the forming of images thereupon, said screen viewing area of said screen housing being externally accessible for forming images magnetically thereupon and being movable along with said screen housing between the docked position and the extended position, said magnetic drawing screen means including an obverse surface facing outwardly from said screen housing which is adapted to have magnetic images formed thereupon and a reverse surface facing inwardly oppositely from said obverse surface;
D. a magnetic eraser means secured to said base housing and extending outwardly therefrom into said screen housing to a position immediately adjacent said magnetic drawing screen means, said magnetic drawing screen means being adapted to move immediately adjacently over said magnetic eraser means responsive to movement of said screen housing between the docked position and the extended position for refreshing of the magnetic drawing screen means by erasing of any images displayed thereupon, said magnetic eraser means being positioned within said screen housing at a position immediately adjacent said reverse surface of said magnetic drawing screen means to facilitate erasing thereof responsive to movement of said screen housing between the docked position and the extended position as said reverse surface of said magnetic drawing screen means passes over said magnetic eraser means; and
E. a magnetic stylus means for facilitating the forming of images on said magnetic drawing screen means.

21. A magnetic drawing apparatus comprising:
A. a base housing defining a template retaining chamber means therein, said base housing further defining a stylus retaining chamber means therein, said base housing further additionally defining a screen guide recess means therewithin;
B. a screen housing movably secured with respect to said base housing and defining a screen viewing area, said screen housing being movable between a docked position adjacent said base housing and an extended position extending outwardly away therefrom, said screen housing being movable slideably with respect to said base housing between said docked position and said extended position, said screen housing further including a docking detent adapted to exert a flexibly resiliently bias against said base housing responsive to positioning of said screen housing in said docked position to facilitate retaining thereof in said docked position, said screen housing defining an access opening means therein which provides said screen viewing area with said magnetic drawing screen means mounted extending thereover to be externally accessible for facilitating the formation of images thereupon, said decorative theme panel defined on said base housing at a position thereon beneath said screen housing responsive to positioning of said screen housing in said docked position and being externally viewable responsive to movement of said screen housing to said extending position, said screen housing being slideably movement along said screen guide recess means, said screen housing being positionable within said screen guide recess means for facilitating movement thereof to the docked position and being moveable outwardly away therefrom for facilitating movement to said extended position, said screen guide recess facilitating guiding movement of said screen housing relative to said base housing during movement thereof between said docked position and said extending position;
C. a magnetic drawing screen means attached to said screen housing adjacent said screen viewing area thereof for selectively facilitating the forming of images thereupon, said screen viewing area of said screen housing being externally accessible for forming images magnetically thereupon and being movable along with said screen housing between the docked position and the extended position, said magnetic drawing screen means including an obverse surface facing outwardly from said screen housing which is adapted to have magnetic images formed thereupon and a reverse surface facing inwardly oppositely from said obverse surface;
D. a magnetic eraser means secured to said base housing and extending outwardly therefrom into said screen housing to a position immediately adjacent said magnetic drawing screen means, said magnetic drawing screen means being adapted to move immediately adjacently over said magnetic eraser means responsive to movement of said screen housing between the docked position and the extended position for refreshing of the magnetic drawing screen means by erasing of any images displayed thereupon, said magnetic eraser means being positioned within said screen housing at a position immediately adjacent said reverse surface of said magnetic drawing screen means to facilitate erasing thereof responsive to movement of said screen housing between the docked position and the extended position as said reverse surface of said magnetic drawing screen means passes over said magnetic eraser means, said magnetic eraser means being positioned in abutment with respect to said reverse surface of said magnetic drawing screen means to facilitate erasing thereof responsive to movement of said screen housing between said docked position and said extended position;
E. a magnetic stylus means for facilitating the forming of images on said magnetic drawing screen means, said magnetic stylus means being selectively positionable within said stylus retaining chamber means for storage thereof; and
F. at least one drawing template defining depressions therein for facilitating forming of images on said magnetic drawing screen means, said template retaining chamber means being adapted to receive at least one of said drawing templates therewithin for storage thereof.
